(19) United States
(12) Patent Application Publication
(10) Pub. No.: US 2012/0110767 A1
(43) Pub. Date: May 10, 2012

(54) Apparatus for Polishing Teeth

(76) Inventor: Chuck Newnham, London, KY (US)

(21) Appl. No.: 12/939,306

(22) Filed: Nov. 4, 2010

(51) Int. Cl. A61C 17/00; A46B 9/04

(52) U.S. Cl. 15/167.1; 15/236.01

(57) ABSTRACT

A tooth polishing device includes a rubber or elastomeric surface for scrubbing or polishing teeth. The scrubbing surface is attached to a series of one or more deformable tubes that allow the scrubbing surface to flex away from the teeth as excessive pressure is applied. The tubes are aligned laterally to the face of a brush handle in order to provide the flexible support to the scrubbing surface. The tubes are formed of elastomeric material as well that may be softer than the material used for the scrubbing surface.

### BACKGROUND OF THE INVENTION

1. Field of the Invention

The present invention relates generally to personal hygiene and more particularly to teeth cleaning.

2. Description of Related Art

Oral hygiene is one of the most visible aspects of day-to-day cleanliness and impacts our personal interaction with one another. In addition, oral hygiene has been linked to overall health and maintaining clean teeth has proven to have many health benefits.

Traditionally the regimen for teeth cleaning has involved brushing and flossing; even though many people do not even perform both those steps regularly. That traditional regimen, however, can be improved.

At the dentist, an additional teeth cleaning step includes a hard rubber cup that is used to polish teeth. The cup can be used with or without gritty paste. This cleaning step removes a number of hardened materials that are difficult to remove from teeth with just brushing and flossing.

Thus, there is currently a need not met by conventional toothbrushes for a tooth cleaner or polisher that can improve a person's ability to clean their teeth at home.

### BRIEF SUMMARY OF THE INVENTION

Embodiments of the present invention relate to a tooth polishing device includes a rubber or elastomeric surface for scrubbing or polishing teeth. The scrubbing surface is attached to a series of one or more deformable tubes that allow the scrubbing surface to flex away from the teeth as excessive pressure is applied. The tubes are aligned laterally to the face of a brush handle in order to provide the flexible support to the scrubbing surface. The tubes are formed of elastomeric material as well that may be softer than the material used for the scrubbing surface.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

Various aspects of embodiments of the present invention are illustrated by way of example, and not by way of limitation, in the accompanying drawings, wherein:

FIGS. 1A and 1B are a side view and front view, respectively of a teeth polisher in accordance with the principles of the present invention.

FIGS. 2A and 2 B are a side view and front view, respectively of a teeth polisher in accordance with the principles of the present invention.

FIGS. 3A and 3B are a side view and front view, respectively of a teeth polisher in accordance with the principles of the present invention.

FIGS. 4 and 5 illustrate other embodiments of a teeth polisher in accordance with the principles of the present invention.

FIGS. 6A and 6B are a side view and front view, respectively of a teeth polisher in accordance with the principles of the present invention.

### DETAILED DESCRIPTION OF INVENTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

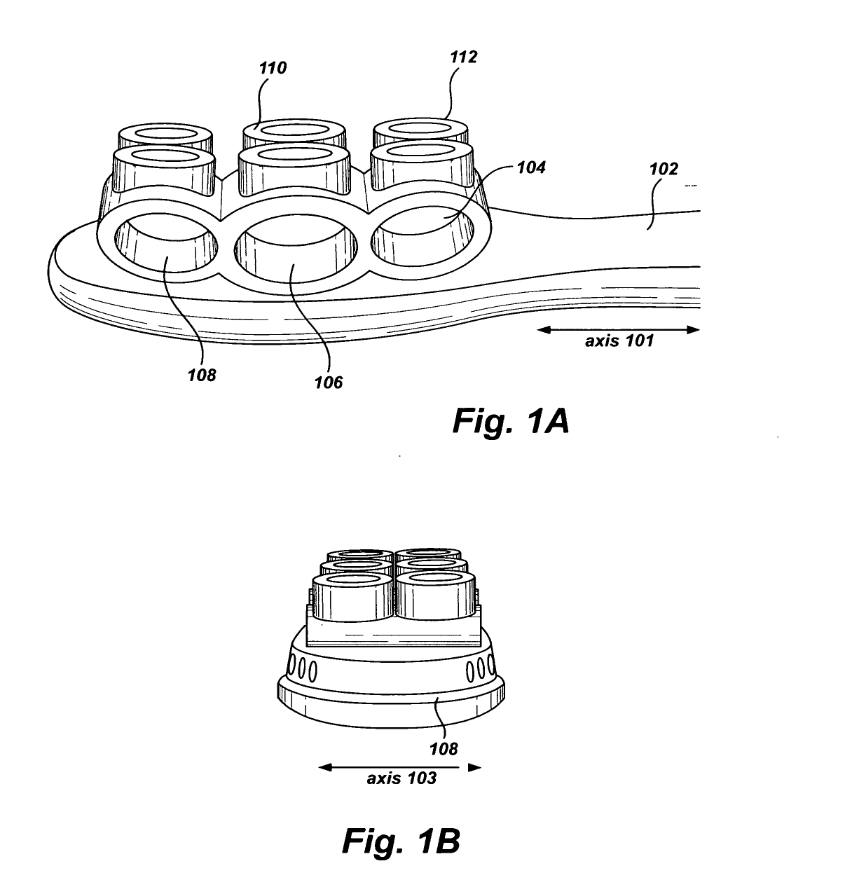

The teeth polisher of FIG. 1A includes a shaft 102 that resembles a conventional toothbrush. At a far end of the shaft 102 is a teeth scrubber or polisher in accordance with the principles of the present invention. A plurality of tubes 104, 106, 108 are provided and the end of the shaft 102. These tubes are arranged substantially laterally in relation to the axis of the shaft. In other words, the major axis of each of the tubes 104, 106, 108 is substantially parallel to that of the shaft's axis 101. The tubes 104, 106, 108 provide a support for an attached cleaning, scrubbing, or polishing surface 110.

The tubes 104, 106, 108 can be formed of a flexible material such as an elastomeric or rubber material. One of ordinary skill will recognize that the specific material of the tubes 104, 106, and 108 can vary without departing from the scope of the present invention. The selection of the material is made such that the tubes 104, 106, 108 can deform or compress as pressure is applied to the cleaning surface 110.

Similar to conventional toothbrushes that can selected with different levels of firmness, embodiments of the present invention can also be made of different materials so as to offer varying levels of firmness. Thus, tubes constructed of a harder material will deform less under a given pressure and thus provide more firmness for the cleaning surface 110. The term “cleaning surface” is used to generically refer to the surface which contacts the teeth as the apparatus of FIG. 1 is being used. The use of this term is intended to encompass activities that accomplish any of brushing, scrubbing, or polishing teeth.

From the front view of FIG. 1B, the major axis 103 of the tubes can be seen more clearly. Thus, in relation to the shaft, the two axes 102 and 103 are perpendicular to one another but each lie in a respective plane that is substantially parallel to one another.

The tubes 104, 106, 108 can be individually formed pieces that are aligned side-by-side with one another and attached to the end of the shaft 102 or they can be an integrally formed piece, such as a molded rubber piece, that has cylindrical voids which are arranged substantially parallel to one another. As far as the diameter of the individual tubes 104, 106, 108, the diameters can be substantially the same size or they can vary from one another. For example, in FIG. 1A, the diameter of tube 106 is larger than the other tubes 104, 108. From the front view of FIG. 1B, the length of the tubes are seen to be about the same (although these can differ as well) and the length is about the width of the end of the shaft 102. In one variant, the length of the tubes 104, 106, 108 can be longer than the width of the end of the shaft 102 and thereby provide additional cleaning surfaces.

One example cleaning surface 110 is shown in FIG. 1A. A number of vertical tubes (e.g., 112) are arranged on the top of the tubes 104, 106, 108. The tips of these tubes (e.g., 112) contact the surface of a person's teeth and provide the cleaning action. Because a number of rubber or elastomeric materials that are suitable for the tubes 104, 106, 108 also have cleaning properties for teeth, the cleaning surface 110 may simply be the top outside surface of the tubes 104, 106, 108.

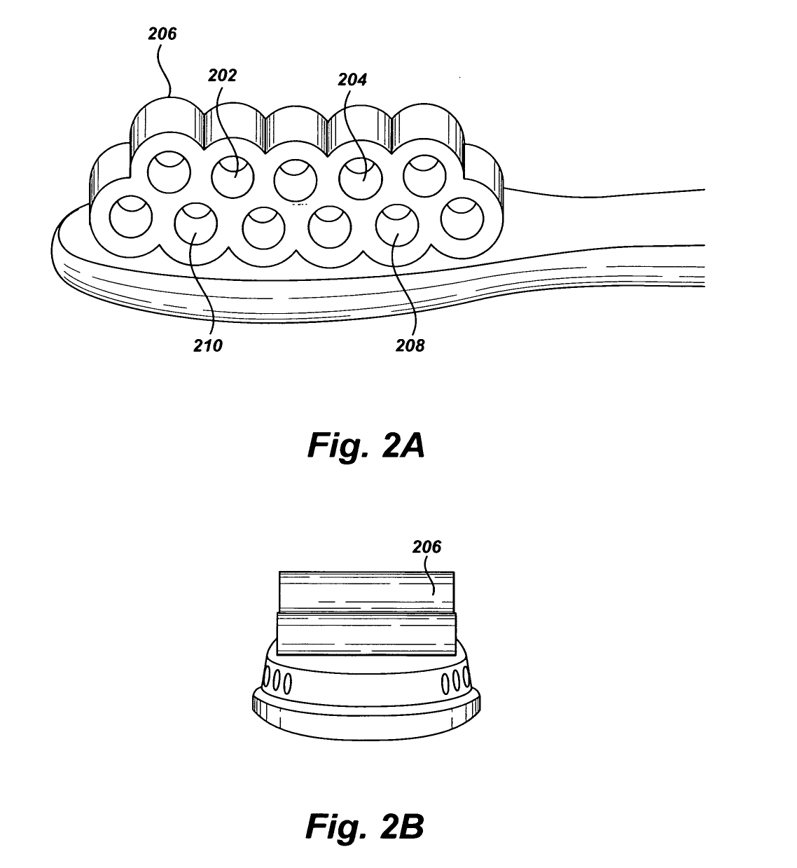

FIGS. 2A and 2B show a different cleaning surface and different number of support tubes. Thus, it is apparent to one of ordinary skill that the number of support tubes can vary without departing from the scope of the present invention. For example, 3 or 6 tubes can be used as depicted in FIGS. 1A and 2A, respectively, but more or fewer tubes can be utilized. Even one tube can be used to provide the flexible support for a cleaning surface as contemplated within the scope of the present invention.

In FIG. 2A, a plurality of additional tubes 202, 204 are positioned atop the support tubes 208, 210. An outside top surface 206 of the additional tubes provides a cleaning surface for a person's teeth.

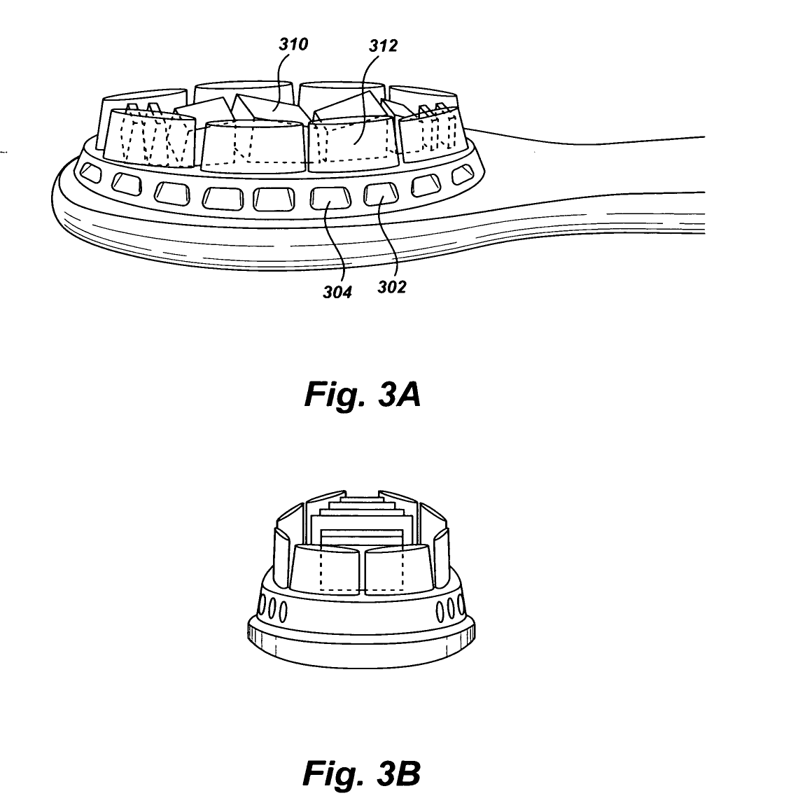

FIGS. 3A and 3B illustrate a number of variations that are intended to be within the scope of the present invention. The tubes 302, 304 are more rectangular in cross section and smaller in comparison to the tubes of the previous embodiments. Also the cleaning surface is comprised of multiple, solid rubber (or elastomeric) blocks 310. These blocks can have flat or angled tops and be positioned around the head of the device of FIG. 3A. The cleaning surface can also include pieces (e.g., 312) that resemble squeegees or blades. The numbers and sizes of these blocks 310 and blades 312 can vary as well as their relative alignment to one another without departing from the scope of the present invention. The blocks 310 can be segmented as well. For example if the block 310 is segmented along its length into multiple pieces, then the pieces can flex relative to one another. The blocks 310 and blades 312 can have different relative hardnesses to one another and may, as well, differ in hardness from the material used to form the support tubes.

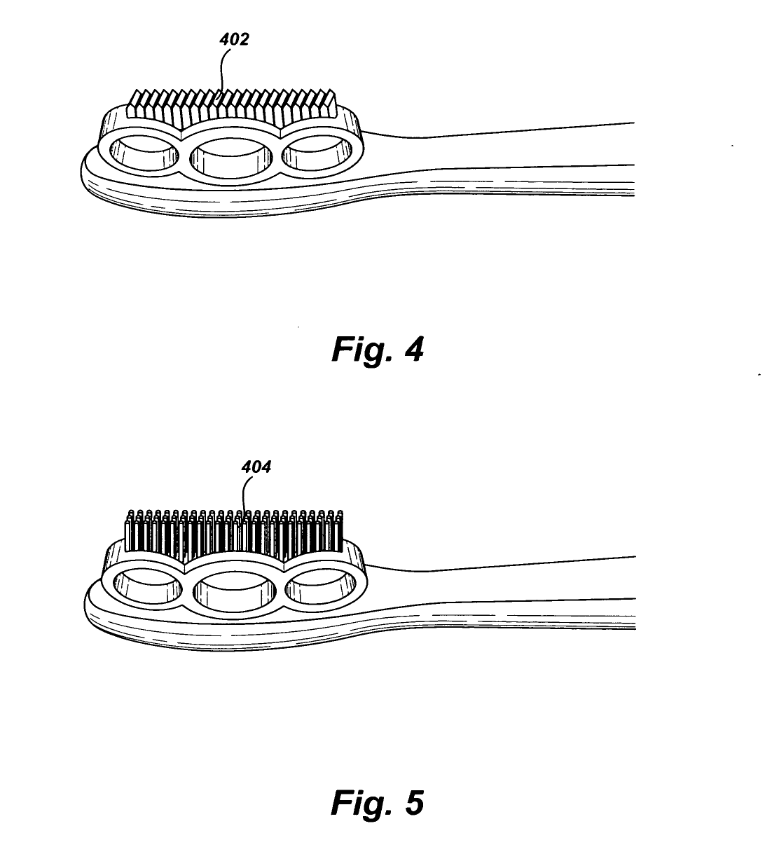

FIG. 4 is an example of a cleaning surface 402 that includes a plurality of vertical blades arranged along the top of a number of support tubes. In FIG. 5, the cleaning surface 404 includes a number of bristles. These bristles can be conventional synthetic fiber bristles or a thicker bristle made from rubber or an elastomeric material.

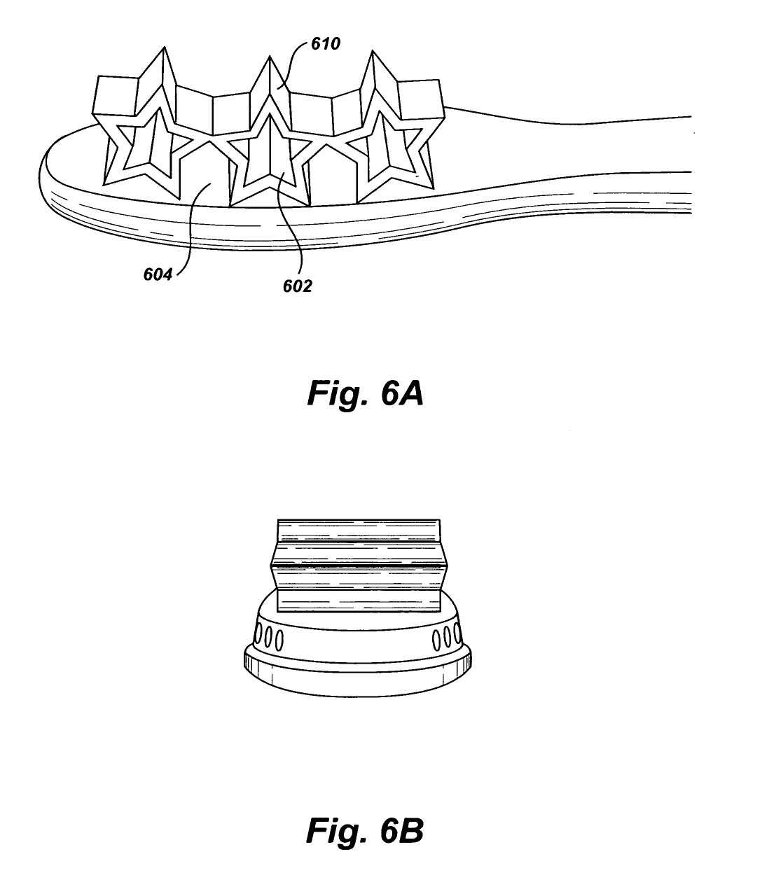

FIGS. 6A and 6B illustrate a variation of the present invention having a cross-sectional shape of a star with the cleaning surface 610 being the top surface of the stars. In this instance, the void 602 within the star allows deformation to occur and the void 604 between adjacent stars allows deformation to occur as well. Thus, the support tubes of the present invention are not necessarily circular in cross-section. For example, a cross sectional shape of a square, rectangle, triangle, circle, ellipse, parallelogram, and other geometric shapes are contemplated within the scope of the present invention. The term “tube” is intended to encompass a shape in which a hollow, or void, allows an outside surface around the void to compress and deform. Also, the tubes shown in the above figures happen to have both ends open but the ends could be closed as well.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for cleaning teeth comprising:
a handle including a first end, a shaft extending along a first axis, and a second end;
a support for an affixed teeth cleaning surface, the support coupled with the second end and comprising a plurality of tubes positioned side-by-side; each of the plurality of tubes having a respective major axis such that a first plane in which the first axis lies is substantially parallel with a second plane in which each respective major axis lies; and
wherein the plurality of tubes are comprised of an elastomeric material such that each of the plurality of tubes is deformable under pressure.

2. The apparatus of claim 1, wherein the plurality of tubes comprise at least three tubes.

3. The apparatus of claim 1, wherein the respective major axis of each of the plurality of tubes is substantially perpendicular to the first axis.

4. The apparatus of claim 1, wherein each of the plurality of tubes have a circular cross-section.

5. The apparatus of claim 4, wherein each of the plurality of tubes have a substantially same diameter.

6. The apparatus of claim 1, wherein each of the plurality of tubes has a cross-sectional shape of one of a star, a rectangle, a square, a triangle, and an ellipse.

7. The apparatus of claim 1, wherein the teeth cleaning surface includes an outer surface of the plurality of tubes.

8. The apparatus of claim 1, wherein the teeth cleaning surface includes a plurality of bristles.

9. The apparatus of claim 1, wherein the teeth cleaning surface includes one or more additional tubes positioned on top of the plurality of tubes and wherein the one or more additional tubes are aligned substantially similar to the plurality of tubes.

10. The apparatus of claim 1, wherein the teeth cleaning surface includes one or more blocks of elastomeric material wherein each of the blocks has a major axis that lies in a plane substantially perpendicular to the first axis.

11. The apparatus of claim 1, wherein the plurality of tubes are formed as an integral assembly that is mechanically coupled with the second end.

12. The apparatus of claim 1, wherein the plurality of tubes are individually formed and assembled onto the second end.

13. The apparatus of claim 10, wherein the teeth cleaning surface further comprises one or more elastomeric bristles.

14. The apparatus of claim 10 wherein a first material of the plurality of tubes is more compressible that a second material of the one or more blocks.

15. The apparatus of claim 10, wherein at least some of the one or more blocks are segmented in a direction substantially parallel to its respective major axis such that resulting segments flex relative to one another.

16. The apparatus of claim 1, wherein each of the plurality of tubes has substantially a same length.

17. The apparatus of claim 16, wherein the substantially same length is about a width of the second end.

18. The apparatus of claim 16, wherein the substantially same length is greater than a width of the second end.

19. An apparatus for cleaning teeth comprising:
a handle including a first end, a shaft extending along a first axis, and a second end;
a support for an affixed teeth cleaning surface, the support coupled with the second end and comprising at least one tube having a respective major axis substantially perpendicular to the first axis but a first plane in which the first axis lies is substantially parallel with a second plane in which the major axis lies; and
wherein the at least one tube is comprised of an elastomeric material such that the at least one tube is deformable under pressure.

20. The apparatus of claim 19, wherein the support further comprises:
at least one additional tube positioned alongside the at least one tube and aligned substantially similar to the at least one tube.
